(19) United States
(12) Patent Application Publication
(10) Pub. No.: US 2025/0273769 A1
(43) Pub. Date: Aug. 28, 2025

(54) BATTERY MODULE COATED WITH LOW-EMISSION LAYER AND BATTERY PACK INCLUDING THE SAME

(71) Applicant: SK On Co., Ltd., Seoul (KR)

(72) Inventor: Woo Young JO, Daejeon (KR)

(21) Appl. No.: 19/060,789

(22) Filed: Feb. 24, 2025

(30) Foreign Application Priority Data
Feb. 26, 2024 (KR) 10-2024-0027277

(51) Int. Cl. H01M 10/658; H01M 50/209; H01M 50/224; H01M 50/51; H01M 50/512

(52) U.S. Cl. CPC H01M 10/658; H01M 50/209; H01M 50/224; H01M 50/51; H01M 50/512

(57) ABSTRACT

Provided are a battery module including a plurality of battery cell assemblies connected in series or parallel; and a battery case accommodating the battery cell assemblies, wherein at least one surface of the battery case includes a low-emission layer having a surface emissivity of 0.5 or less, and a battery pack including the same. By reducing the radiation heat transfer within a battery system, the propagation of battery thermal runaway may be effectively suppressed. Accordingly, a battery pack with improved stability, life characteristics, and cell efficiency may be manufactured.

### CROSS-REFERENCE TO RELATED APPLICATIONS

This application claims priority under 35 U.S.C. § 119 to Korean Patent Application No. 10-2024-0027277, filed on Feb. 26, 2024, the disclosure of which is incorporated herein by reference in its entirety.

### TECHNICAL FIELD

The embodiments of the present disclosure relate to a battery module coated with a low-emission layer and a battery pack including the same, and in particular, to a battery system capable of efficiently preventing the propagation of thermal runaway by using a battery module coated with a low-emission layer.

### BACKGROUND

Recently, as the electric vehicle market has grown rapidly, interest in battery systems with high safety and high energy characteristics has increased. Battery cells used in electric vehicles are accommodated in battery cases formed of metal or plastic material for physical/chemical protection and are provided in the form of battery modules in an EV system. In particular, since stability, reliability, and efficiency significantly vary depending on how the modules of a battery are arranged, research on not only improving the inherent capacity of battery cells but also on developing an efficient battery system has been actively conducted.

Recently, technologies for improving battery efficiency by suppressing thermal runaway and thermal propagation of batteries have become an important portion of battery system design. Specifically, heat transfer may be divided into conduction, convection, and radiation, and conduction or convection is usually considered the most important method for heat transfer within a battery system. Accordingly, various solutions have been studied to suppress conduction and convection within a battery system.

However, when a high temperature environment is created due to battery thermal runaway, heat transfer by radiation within a battery system increases in proportion to the fourth power of the temperature, and this causes a rapid increase in the contribution of heat transfer by radiation. Therefore, when thermal runaway occurs in a specific battery cell, heat rapidly spreads, causing a problem in which thermal runaway propagates from battery cell to battery cell or from battery module to battery module, but there is no solution to effectively suppress radiation heat transfer yet.

Therefore, a solution that may block not only heat transfer by conduction or convection but also heat transfer by radiation when battery thermal runaway occurs within a battery system is urgently needed.

### SUMMARY

An embodiment of the present disclosure is directed to providing a battery module capable of effectively preventing thermal runaway propagation between battery modules by minimizing radiation heat transfer within a battery system and a battery pack including the same.

In an embodiment, a battery module includes a plurality of battery cell assemblies connected in series or parallel; and a battery case accommodating the battery cell assemblies, wherein at least one surface of the battery case includes a low-emission layer having a surface emissivity of 0.5 or less.

The low-emission layer may include one or a combination of two or more selected from the group consisting of stainless steel, aluminum, copper, nickel, zinc, and chromium.

A thickness of the low-emission layer may be 1 to 50 μm.

A maximum amount of heat transfer per area of the battery module when thermal runaway occurs may be 40,000 W/m² or less.

The low-emission layer may be included in at least two side surfaces of the battery case.

The low-emission layer may have a surface emissivity of 0 to 0.3.

In another embodiment, a battery pack includes a plurality of battery modules arranged in series or in parallel, wherein the battery module includes a plurality of battery cell assemblies connected in series or in parallel and a battery case accommodating the battery cell assemblies, and wherein at least one surface of the battery case includes a low-emission layer having a surface emissivity of 0.5 or less.

The low-emission layer may include one or a combination of two or more selected from the group consisting of stainless steel, aluminum, copper, nickel, zinc, and chromium.

A thickness of the low-emission layer may be 1 to 50 μm.

The low-emission layer may have a surface emissivity of 0 to 0.3.

In one battery module and an adjacent battery module, a battery case of the one battery module may include a low-emission layer on a side surface facing the adjacent battery module.

In one battery module and an adjacent battery module, a battery case of the one battery module may include a low-emission layer on one or two or more side surfaces including an upper surface and a side surface facing the adjacent battery module.

In one battery module and an adjacent battery module, a battery case of the one battery module may include a low-emission layer on four or more side surfaces including an upper surface and a side surface facing the adjacent battery module.

In another adjacent battery module located at a distance of 1 to 20 cm from one battery module, a maximum amount of heat transfer per area transferred from one battery module to the adjacent battery module at room temperature (25° C.) during thermal runaway may be 40,000 W/m² or less.

In another adjacent battery module located at a distance of 1 to 20 cm from one battery module, when one battery module experiences thermal runaway, a time taken for the adjacent battery module at room temperature (25° C.) to reach thermal runaway may be 200 seconds or longer.

Other features and aspects will be apparent from the following detailed description, the drawings, and the claims.

### BRIEF DESCRIPTION OF THE DRAWINGS

FIG. 1 is a schematic diagram of a battery module according to an embodiment of the present disclosure.

FIG. 2(A) is a cross-section of a battery module according to an embodiment of the present disclosure, and FIG. 2(B) is a cross-section of a battery module according to another embodiment of the present disclosure.

FIG. 3(A) is a cross-section of a battery pack including a plurality of battery modules according to an embodiment of the present disclosure, and FIG. 3(B) is a cross-section of a battery pack including a plurality of battery modules according to another embodiment of the present disclosure.

### DETAILED DESCRIPTION

Various advantages and features of the embodiments of the present disclosure will become apparent from the embodiments described below. However, the embodiments are not limited to the described embodiments, but may also be implemented in various other embodiments. The embodiments are provided for illustration purposes and should not limit the scope of the present disclosure.

Hereinafter, embodiments are described with reference to the accompanying drawings. In the drawings, like reference numerals refer to like elements.

Unless otherwise defined, technical and scientific terms used in the present disclosure may be used in the sense that they are commonly understood by those skilled in the art to which the present disclosure pertains. Throughout the present disclosure, when a feature is said to include another feature, this does not mean that other features not mentioned are excluded, but rather that other features may be included. In addition, the singular includes the plural unless specifically stated in the phrase.

In the present disclosure, when a portion of a layer, a film, a region, and a plate is present “on” or “at an upper portion of” another portion, the case includes not only a case in which the portion is present “immediately on” another portion, but may also include a another case in which still portion is present therebetween.

In addition, when a portion of a layer, a film, a region, and a plate is present on “one surface” or “one side” of another portion, the case includes not only a case in which the portion is in direct contact with another portion but also a case in which another portion is present therebetween.

In addition, units used in the present disclosure without particular mention are based on weights, and as an example, a unit of % or ratio refers to a wt % or a weight ratio, and the wt % refers to a wt % of any one component in a composition with respect to the total composition, unless otherwise defined.

In addition, a numerical range used in the present disclosure includes all values within the range including the lower limit and the upper limit, increments logically derived in a form and span in a defined range, all double limited values, and all possible combinations of the upper limit and the lower limit in the numerical range defined in different forms. As an example, when it is defined that a numerical value is 100 to 10,000, specifically 500 to 5,000, it should be interpreted as being that a numerical range of 500 to 10,000 or 100 to 5,000 is also described. Unless otherwise defined, values which may be outside a numerical range due to experimental error or rounding of a value are also included in the defined numerical range.

The term “comprise” in the present disclosure is an open-ended description having a meaning equivalent to the expression, such as “provided”, “contain”, “have”, or “is/are characterized”, and does not exclude elements, materials or processes which are not further listed.

The term “substantially” in the present disclosure means that other elements, materials, or processes which are not listed together with specified elements, materials, or processes may be present in an amount which does not have an unacceptable significant influence on at least one basic and novel technical idea of the present disclosure.

In addition, ‘thermal runaway’ as used in this specification means that a surface temperature of at least a portion of a cell surface reaches 400° C. (673.15K) based on the cell. In another viewpoint, ‘thermal runaway’ means that a surface temperature of at least a portion of a module case surface reaches 400° C. (673.15K) based on the module.

In addition, ‘surface emissivity’ as used in this specification refers to the ratio of radiant energy radiated from an actual surface to radiant energy radiated from a black body at the same temperature. In this disclosure, the surface emissivity was measured according to ASTM E408, a standard measurement method.

Hereinafter, an embodiment according to this disclosure will be described in more detail.

In order to solve the problem of the related art that the contribution of heat transfer by radiation within a battery system rapidly increases when a high temperature environment is created due to the occurrence of battery thermal runaway, the present disclosure provides a battery module capable of reducing the amount of radiation heat transfer per area and efficiently delaying the time of reaching thermal runaway by coating a low-emission layer on a battery case between adjacent battery modules and also provides a battery pack and battery system capable of effectively preventing the propagation of thermal runaway between the battery modules.

In the related art, when battery cells physically contact each other, heat transfer occurs by conduction rather than radiation between cells, so if a low-emission layer is located between battery cells, it may be difficult to expect the effect of reducing the amount of radiation heat transfer by introducing a low-emission layer. However, according to an embodiment of the present disclosure, a battery module may exhibit an excellent effect of reducing the amount of radiation heat transfer between modules that are separated from each other by coating one surface of the battery case with a low-emission layer, and since the low-emission layer does not directly contact the cells, deterioration of the material may be minimized, so that it may be used for a long period of time without deterioration of physical properties. In addition, it is possible to manage the battery system on a module-unit scale rather than a small scale, and by replacing (using) the battery case coated with a low-emission layer without excessive introduction of low-emissivity materials, it is possible to manufacture a battery module that is lighter than the related art, and since it is possible to manufacture a battery module and a battery pack including the same that may effectively prevent thermal runaway propagation without an additional process in the existing battery module assembly process, the embodiments of the present disclosure have the advantage of being more economical than the related art in terms of work efficiency.

Hereinafter, each component of a battery module according to an embodiment will be described first.

The embodiments of the present disclosure provide a battery module including a plurality of battery cell assemblies connected in series or in parallel and a battery case that accommodates the battery cell assemblies and including a low-emission layer having a surface emissivity of 0.5 or less on at least one surface of the battery case.

The battery cell may be any electrochemical device. A non-limiting embodiment of the electrochemical device may be a lithium secondary battery. The battery cell assembly may be formed by connecting two or more, five or more, eight, ten, twelve, or sixteen or twenty or fewer battery cells in series or in parallel, but the battery cell assembly is not limited thereto.

According to an embodiment, the battery case is a general case that accommodates the battery cell assembly, i.e., surrounds the outside of the cell assembly, and the battery case is provided to protect at least one outer surface of the assembly including a plurality of battery cells, thereby protecting the battery cell assembly from external impact or foreign substances and enhancing the strength and rigidity of the battery module to improve the assemblability. The battery case may be any battery case known in the art of battery module technology.

According to an embodiment, the low-emission layer may be included on one surface of the exterior or interior of the battery case, may be included on one surface of the exterior, or may be included on one surface of both the exterior and interior. Through this, the amount of radiation heat transfer per area of a specific battery module may be reduced, and the propagation of thermal runaway to an adjacent battery module may be effectively suppressed.

In an embodiment, the low-emission layer may have a surface emissivity of 0.5 or less, greater than 0 and less than 0.5, 0 to 0.4, 0 to 0.3, 0 to 0.2, 0 to 0.1, or 0 to 0.05. Outside the above range, the amount of radiation heat transfer is not effectively reduced, and thus the effect of delaying or preventing the propagation of thermal runaway intended to be implemented cannot be achieved.

In an embodiment, the low-emission layer may be formed of any material without significant limitation as long as it satisfies the above surface emissivity range, and the low-emission layer may be formed of a metal material having a surface emissivity of 0.5 or less, greater than 0 and less than 0.5, 0 to 0.4, 0 to 0.3, 0 to 0.2, 0 to 0.1, or 0 to 0.05. For example, the low-emission layer may include one or a combination of two or more selected from the group consisting of stainless steel, aluminum, copper, nickel, zinc, and chromium.

According to an embodiment, a thickness of the low-emission layer may be 0.1 to 200 μm, 1 to 100 μm, 1 to 50 μm, or 5 to 30 μm.

According to an embodiment, the low-emission layer may be coated on at least one surface of the battery case, and a method of coating the low-emission layer may be a commonly used or known coating method without limitation, and for example, a coating method selected from spin coating, roll coating, spray coating, dip coating, flow coating, doctor blade and dispensing, inkjet printing, offset printing, screen printing, pad printing, gravure printing, flexography printing, stencil printing, imprinting, xerography, lithography, etc. may be used, or a method of bonding a manufactured metal thin film onto the battery case may be used, but the methods are not limited thereto.

In an embodiment, the battery module may further include a cooling system, and may include a metal plate including at least one of copper, silver, and aluminum having high thermal conductivity to release heat generated by the battery cell. For example, the cooling member may be a plate formed of aluminum to secure mechanical rigidity of the battery module while having a predetermined thermal conductivity. However, the material and shape of the cooling member described above are an example and are not limited thereto, and any cooling member known in the art of battery module technology may be applied. Alternatively, a non-limiting embodiment of the cooling system may include a cooling system having a cooling channel, and the cooling channel is formed between an outer battery case and an inner metal plate, and heat generated by the battery cell may be released as coolant moves along the cooling channel.

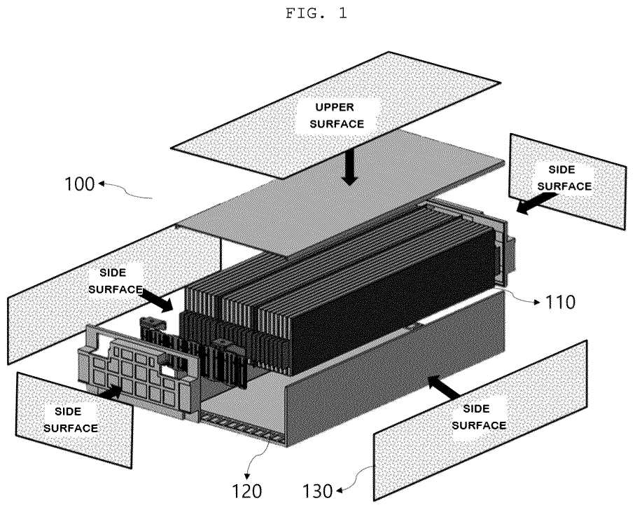

FIG. 1 is a schematic diagram of a battery module according to an embodiment of the present disclosure. The battery module may include all components of general battery modules known in the art unless otherwise specified, and it should be noted that even if detailed components of the battery module are not specifically depicted in the drawing, the components not depicted are not excluded.

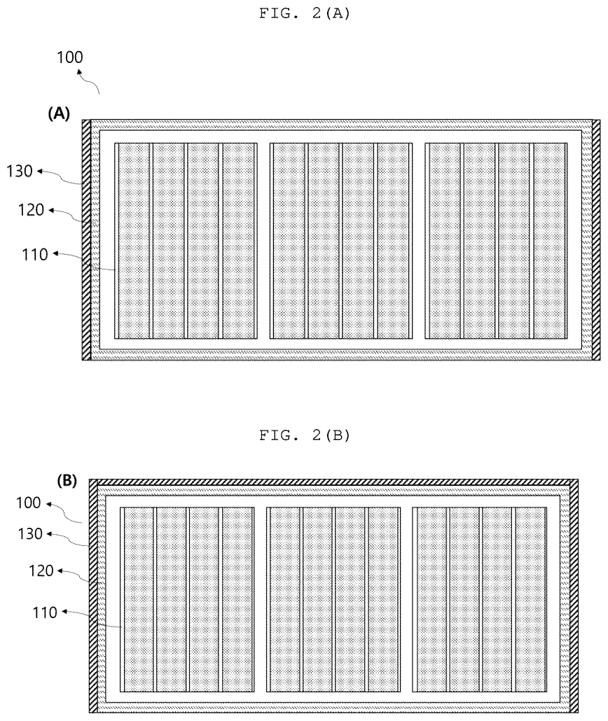

In addition, although FIGS. 1, 2(A), and 2(B) illustrate a schematic diagram and a cross-sectional view of a prismatic battery module, the embodiments of the present disclosure are not limited to a specific type or shape of battery module, and it should be noted that the embodiments may include all types and shapes of battery modules in which each component in a battery module of various types and shapes, such as a cylindrical or polygonal type, satisfies the relative positional relationship described below, and the interaction of each component is performed identically to achieve the prevention of the propagation of thermal runaway intended to be implemented by the embodiments of the present disclosure.

Specifically, in FIGS. 1, 2(A) and 2(B), the battery module 100 according to an embodiment may include a battery cell assembly 110 including a plurality of battery cells, a battery case 120 surrounding the outside thereof, and a low-emission layer 130 coated on at least one surface of the battery case 120. The low-emission layer 130 may be included on an outer surface of the battery case 120, may be included on an inside surface, or may be included on both an outer surface and an inside surface. In an embodiment, the low-emission layer 130 may be included on both the entire outside surface of the battery case, or the entire inside surface of the battery case, or both the entire outer surface and entire inside surface of the battery case 120. Preferably, as shown in FIGS. 1, 2(A), and 2(B), the low-emission layer 130 may be included on at least a part or the entire outer surface of the battery case 120.

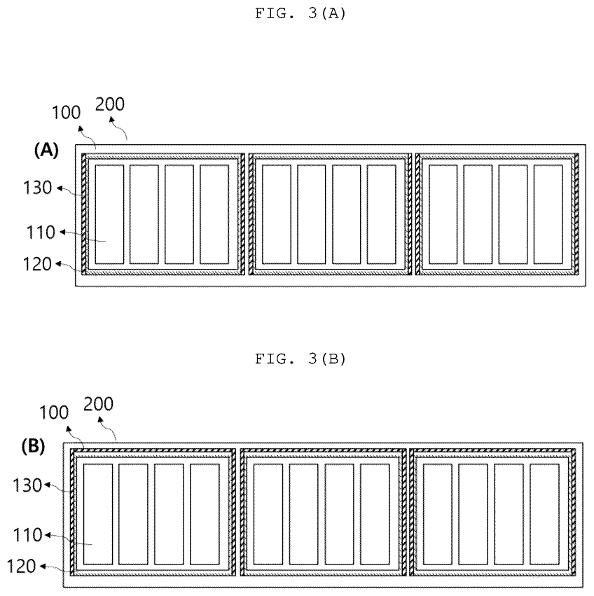

According to an embodiment, as shown in FIG. 1, the low-emission layer 130 may be included on at least one or more or two or more side surfaces of the battery case 120 or may be included on all four side surfaces. In an embodiment, only a hexahedral prismatic battery is illustrated but the embodiments are not limited thereto. The low-emission layer may be included on one or more side surfaces of a battery case having different shapes. Preferably, the low-emission layer may be included on the side surface which is adjacent to an adjacent battery module described below, and in the case of a battery module having a continuous array structure, the low-emission layer may be included on the side surface of the battery case perpendicular to the module array direction, as shown in FIG. 2(A) and FIG. 3(A).

According to another embodiment, as shown in FIG. 1 and FIG. 2(B), the low-emission layer 130 may be included on an upper surface and at least one or more or two or more side surfaces of the battery case 120, or may be included on all of the upper surface and four side surfaces. In this case, a lower surface (bottom surface) may not include the low-emission layer. As an example, a hexahedral prismatic battery is illustrated, and the embodiment is not limited thereto, and the low-emission layer may be included on the upper surface and side surfaces of various shapes of battery cases, or in the case of a cylindrical battery cell, the low-emission layer may be included on a cylindrical side surface. Preferably, the low-emission layer may be included on the upper surface of the battery module and the side adjacent to the adjacent battery module described below, and in the case of a battery module having a continuous array structure, the low-emission layer may be included on the upper surface and the side surface of the battery case perpendicular to the module array direction, as shown in FIG. 2(B) and FIG. 3(B).

According to an embodiment, when a length of one side surface of the battery module is 530 mm, a height is 100 mm, and a heat transfer area is 0.053 m², the maximum amount of heat transfer of the battery module when thermal runaway occurs may be 2,000 W or less, 1,500 W or less, 1,200 W or less, 1,000 W or less, 500 W or less, or 400 W or less, and the lower limit is not suggested, but may be 0 W or more or 100 W or more.

According to an embodiment, when thermal runaway occurs, the maximum amount of heat transfer per area of the battery module may be 40,000 W/m² or less, 30,000 W/m² or less, 25,000 W/m² or less, 15,000 W/m² or less, 10,000 W/m² or less, or 6,000 W/m² or less, and the lower limit is not limited, but may be 0 W/m² or more or 500 W/m² or more.

The embodiments of the present disclosure provide a battery pack including a plurality of battery modules arranged in series or in parallel, wherein the battery module includes a plurality of battery cell assemblies connected in series or in parallel and a battery case accommodating the battery cell assemblies, and wherein at least one surface of the battery case includes a low-emission layer having a surface emissivity of 0.5 or less. The description of the battery module is the same as described above, so it is omitted.

Specifically, in FIGS. 3(A) and 3(B), a battery pack 200 according to an embodiment is formed such that a plurality of battery modules 100 including a battery cell assembly 110 including a plurality of battery cells, a battery case 120, and a low-emission layer 130 are arranged. As described above, the low-emission layer 130 may be included on the outer surface of the battery case 120, may be included on the inside, or may be included on the outside and inside, but is not limited thereto, and preferably, as shown in FIGS. 3(A) and 3(B), may be included on the outer surface of the battery case 120.

According to an embodiment, as shown in FIG. 3(A), in the battery module arranged adjacent to one battery module, the battery case of the one battery module may include a low-emission layer on at least one or two side surfaces adjacent to the adjacent battery module, that is, on the side surface of the battery case perpendicular to the module arrangement direction.

According to another embodiment, as shown in FIG. 3(B), in a battery module adjacent to one battery module, the battery case of the one battery module may include a low-emission layer on the upper surface and at least one or two side surfaces facing the adjacent battery module, that is, the side surface of the battery case perpendicular to the module arrangement direction. In this case, the lower surface (bottom surface) may not include the low-emission layer.

According to another embodiment, as shown in FIG. 3(B), in a battery module adjacent to one battery module, the battery case of the one battery module may include a low-emission layer on four or more side surfaces including the upper surface and the side surface facing (adjacent to) the adjacent battery module, that is, the side surface of the battery case perpendicular to the module arrangement direction. In this case, the lower surface (bottom surface) may not include the low-emission layer.

In an embodiment, in another adjacent battery module positioned at a distance of 1 to 20 cm from one battery module, the maximum amount of heat transfer (heat amount) per area transferred from one battery module to the adjacent battery module at room temperature (25° C.) during thermal runaway may be 40,000 W/m² or less, 30,000 W/m² or less, 25,000 W/m² or less, 15,000 W/m² or less, 10,000 W/m² or less, or 6,000 W/m² or less, and the lower limit is not suggested, but may be 0 W/m² or more or 500 W/m² or more. The amount of heat transfer may be equal to the maximum amount of heat transfer (q) calculated according to the Stefan-Boltzmann formula.

According to an embodiment, in another adjacent battery module located at a distance of 1 to 20 cm from one battery module, the time taken for the adjacent battery module at room temperature (25° C.) to reach thermal runaway when the one battery module experiences thermal runaway (thermal runaway delay time) may be 200 seconds or more, 300 seconds or more, 400 seconds or more, 500 seconds or more, 600 seconds or more, or 800 seconds or more, and the upper limit is not limited, but may be 5000 seconds or less, or 3000 seconds or less. For the convenience of thermal runaway evaluation, the thermal runaway delay time may be replaced with the result evaluated in a heating device (such as a heating pad)-adjacent battery module structure instead of one battery module-adjacent battery module.

The embodiments of the present disclosure will be described in detail below through examples, but these are intended to describe the embodiments in more detail, and the scope of the present disclosure is not limited by the following examples.

### Examples and Comparative Examples

A battery module having a length of 530 mm, a height of 100 mm, and a width of 220 mm was prepared by assembling a battery cell assembly in which 24 battery cells are connected and a battery case formed of anodized aluminum. At this time, each battery case was formed by bonding a stainless steel foil, copper foil, or aluminum foil thin film to the surface thereof or by spray-coating nickel, zinc, or chrome to form a low-emission layer. The low-emission layer was coated to a thickness of 10±0.5 μm.

In addition, as Comparative Example 1, a basic battery case without a low-emission layer was used, and as Comparative Example 2, a module in which a low-emission layer was introduced between each battery cell instead of the module case was used.

### [Evaluation Example] Thermal Runaway Evaluation

Two manufactured battery modules were prepared, a heating pad was inserted into module 1, and another module 2 was placed 10 cm apart from module 1. At this time, the module case was arranged so that the surfaces (area: 0.053 m²) of length 530 mm X height 100 mm of the module case faced each other. The module 1 was heated with a 1000 W heating pad to induce thermal runaway, and the time taken for the thermal runaway of the module 2 to occur from the time the heating pad started heating was measured as the thermal runaway delay time (seconds). In addition, the maximum amount of heat transfer (q) was calculated according to the Stefan-Boltzmann formula and is shown in Table 1 below. At this time, the maximum amount of heat transfer was measured as the maximum amount of heat transfer at the moment when the heat transfer occurred the most.

TABLE 1

| | | | Maximum | |
|---|---|---|---|---|
| | | | amount of | Thermal |
| | Low- | | heat | runaway |
| | emission | Surface | transfer | delay time |
| | layer | emissivity | [W] | (s) |
| Comparative | — | 0.77 | 2342 | 165 |
| Example 1 | | | | |
| Comparative | Aluminum | 0.2 | 2155 | 177 |
| Example 2 | foil | | | |
| Example 1 | Stainless | 0.5 | 1430 | 240 |
| | steel | | | |
| Example 2 | Copper | 0.4 | 1143 | 280 |
| | foil | | | |
| Example 3 | Aluminum | 0.2 | 639 | 450 |
| | foil | | | |
| Example 4 | Nickel | 0.1 | 414 | 650 |
| Example 5 | Zinc | 0.04 | 307 | 850 |
| Example 6 | Chromium | 0.02 | 243 | 995 |

As shown in Table 1 above, the battery module according to an embodiment showed a result in which the thermal runaway delay time was delayed by including the battery case with a low-emission layer introduced. Through this, it was confirmed that the battery module may suppress the propagation of thermal runaway by effectively blocking heat transfer by radiation from a specific battery module to an adjacent battery module when thermal runaway occurs.

In particular, when comparing Comparative Example 2 and Example 3, it was confirmed that, in the case of Comparative Example 2, which introduced a low-emission layer between cells, the radiation heat transfer blocking effect rarely occurred and there was an insignificant effect in the thermal runaway delay.

The embodiments of present disclosure relate to the battery module coated with a low-emission layer and the battery pack including the same, and in one battery module and an adjacent battery module, the battery case of the one battery module is coated with a low-emission layer on at least one side surface adjacent to the adjacent battery module, thereby minimizing radiation heat transfer within the battery system and effectively suppressing battery thermal runaway. Accordingly, the battery pack with improved stability, life characteristics, and battery efficiency may be manufactured.

Although the embodiments of the present disclosure have been described above, it should be noted that the embodiments are not limited to the described embodiments only. The embodiments may be implemented in various other forms, and a person having ordinary skill in the art may envision many other embodiments without departing from the technical concepts or scope of the present disclosure. Therefore, the embodiments described above should be understood as being simply used as illustrative and not limiting in all aspects. Furthermore, the embodiments may be combined to form additional embodiments.

### LIST OF NUMERALS

100: battery module
110: battery cell assembly
120: battery case
130: low-emission layer
200: battery pack

What is claimed is:

1. A battery module comprising:
a plurality of battery cell assemblies connected in series or parallel; and
a battery case accommodating the battery cell assemblies,
wherein at least one surface of the battery case includes a low-emission layer having a surface emissivity of 0.5 or less.

2. The battery module of claim 1, wherein the low-emission layer includes one or a combination of two or more selected from the group consisting of stainless steel, aluminum, copper, nickel, zinc, and chromium.

3. The battery module of claim 1, wherein thickness of the low-emission layer is 1 to 50 μm.

4. The battery module of claim 1, wherein a maximum amount of heat transfer per area of the battery module when thermal runaway occurs is 40,000 W/m² or less.

5. The battery module of claim 1, wherein the low-emission layer is included in at least two side surfaces of the battery case.

6. The battery module of claim 1, wherein the low-emission layer has a surface emissivity of 0 to 0.3.

7. A battery pack including a plurality of battery modules arranged in series or in parallel,
wherein the battery modules include a plurality of battery cell assemblies connected in series or in parallel and a battery case accommodating the battery cell assemblies, and wherein at least one surface of the battery case includes a low-emission layer having a surface emissivity of 0.5 or less.

8. The battery pack of claim 7, wherein the low-emission layer includes one or a combination of two or more selected from the group consisting of stainless steel, aluminum, copper, nickel, zinc, and chromium.

9. The battery pack of claim 7, wherein a thickness of the low-emission layer is 1 to 50 μm.

10. The battery pack of claim 7, wherein the low-emission layer has a surface emissivity of 0 to 0.3.

11. The battery pack of claim 7, wherein
in one battery module and an adjacent battery module, a battery case of the one battery module includes a low-emission layer on a side surface facing the adjacent battery module.

12. The battery pack of claim 7, wherein, in one battery module and an adjacent battery module, a battery case of the one battery module includes a low-emission layer on one or two or more side surfaces including an upper surface and a side surface facing the adjacent battery module.

13. The battery pack of claim 7, wherein, in one battery module and an adjacent battery module, a battery case of the one battery module includes a low-emission layer on four or more side surfaces including an upper surface and a side surface facing the adjacent battery module.

14. The battery pack of claim 7, wherein, in another adjacent battery module located at a distance of 1 to 20 cm from one battery module, a maximum amount of heat transfer per area transferred from one battery module to the adjacent battery module at room temperature (25° C.) during thermal runaway is 40,000 W/m² or less.

15. The battery pack of claim 7, wherein, in another adjacent battery module located at a distance of 1 to 20 cm from one battery module, when one battery module experiences thermal runaway, a time taken for the adjacent battery module at room temperature (25° C.) to reach thermal runaway is 200 seconds or longer.

16. A battery pack including a plurality of battery modules according to claim 1 arranged in series or in parallel,
wherein the low-emission layer includes one or combination of two or more selected from the group consisting of stainless steel, aluminum, copper, nickel, zinc, and chromium.
